(19) United States
(12) Patent Application Publication
(10) Pub. No.: US 2011/0318084 A1
(43) Pub. Date: Dec. 29, 2011

(54) RETRACTION MECHANISM

(76) Inventors: Uri Zaidman, Kadima (IL); Guy Dagan, Shaar Efraim (IL)

(21) Appl. No.: 13/164,791

(22) Filed: Jun. 21, 2011

Related U.S. Application Data
(60) Provisional application No. 61/358,010, filed on Jun. 24, 2010.

(51) Int. Cl. B43K 24/02

(52) U.S. Cl. 401/109

(57) ABSTRACT

The present invention describes a mechanism and method for retracting an instrument. In a rearward position, a sliding weight aligns an elongated assembly with a rear canal allowing the assembly to slide backward into the canal thereby retracting. When the weight slides forward, it collides with a protrusion on the elongated assembly forcing the elongated assembly forward and pulling the rear of the elongated assembly out of the rear canal. Once the elongated assembly is pulled out of the rear canal, it is unlikely to spontaneously return to the canal and contacts an internal shoulder which locks the elongated assembly in a forward position. Alternatively, means are provided to lock the elongated assembly out of the rear canal when in forward position. Preferably the weight is moved between the forward and rearward position by shaking.

This patent application claims the benefit of U.S. Provisional Patent Application No. 61/358,010 filed 24 Jun., 2010.

### FIELD AND BACKGROUND OF THE INVENTION

The present invention is related to the field of retraction mechanisms; more specifically, the invention may be applied to the field of retractable instruments having a tip that may be extended or retracted for example writing instruments.

A retractable tip has many useful applications. Retractable tip pens are popular because by retracting the writing tip while carrying the pen, the tip is shielded from damage and the clothes of the person carrying the pen are protected from ink stains. Retractable screw drivers and knives are also popular for similar reasons.

A retractable tip is preferable to a removable cover because covers often require two-handed manipulation for removal; covers may get lost, and covers may fall off accidentally. Also pen caps can become a nuisance and even dangerous to small children who like to take things apart and put small parts in their mouths.

For similar reasons, retractable tips may be useful for pocket screw drivers and mechanical pencils. Another application for retractable tips is for markers (particularly white board markers), which allow a user to open and close a marker without worry about manipulating, replacing and keeping track of a cap. For example, keeping track of caps can be especially difficult for a lecturer using a few different colored white board markers.

The disadvantage of common retractable tip mechanisms are 1) they are complex (increasing complexity generally implies increases expense and unreliability) 2) many common retractable tip mechanisms require two hands for operation (e.g., for pens that are opened and closed by twisting) and 3) even when a retractable tip mechanism can be opened or closed with one hand, the user must move and regrip his hand in order to open or close the instrument (e.g., for pens that are opened and closed by depressing a button opposite the writing tip, in order to open or close the pen one must move one's grip from the writing grip and clasp the pen opposite the writing tip with fingers only using one's free thumb to open or close the pen).

Furthermore, there is a general desire of many consumers to have a unique pen that is different from the standard. A pen that opens by a non-standard action (e.g. shaking instead pushing a button) is particularly desirable. Such pens can sell for high prices and particularly if the pen uses a custom refill, selling the refills can be very profitable for the manufacturer.

Therefore, there have developed a few pens which can be opened and closed by simple shaking or inverting. For example Saida '979 (U.S. Pat. No. 4,176,979) discloses a magnetically closed pen that opens automatically when the pen is held in an attitude wherein the writing tip is slanted downward (the usual writing attitude) and closes automatically when the pen is held vertically with the writing tip upward (the preferred storage attitude). Nevertheless, the pen of Saida '979 has a few significant disadvantages. Firstly, the pen must be stored with the writing tip pointed upward. Such a storage direction may lead to leakage of ink from the back of the ink tube. Such a storage attitude may also lead to drying of the pen point and require waiting or shaking to rewet the tip before writing. Such shaking may be problematic with the mechanism of Saida '979. Furthermore, Saida '979 teaches that extending the writing tip and keeping the writing tip extruded depends on keeping the pen tilted so that gravity pushes the rear end of the ink tube against a projection that prevents the tip from retracting, Thus the pen of Siada '979 may not open or may not remain open properly when held at an improper attitude. Furthermore, the pen of Saida '979 requires that the ink tube be magnetically attractive and cannot be used with a standard plastic tube ball-point refill. Kersten '511 (U.S. Pat. No. 2,813,511) discloses a ball-point pen that can be opened by shaking, and can be opened by pulling and releasing a spring clip. The pen of Kersten '511 includes at least a few important disadvantages. Firstly, retracting the writing tip requires complex manipulation of the spring clip. Secondly, in the writing configuration (with tip extended) there is no force holding the ink reservoir cover element 40 up against the shoulder 42 of the pen. Therefore, when the writing tip is pushed down against a writing surface there will be an annoying play as the reservoir cover element 40 retracts very slightly until it contacts the shoulder 42. Thirdly, Kersten '511 requires a magnetizable ink reservoir and cannot use a standard plastic pen refill. Furthermore, in order for the writing tip to lock in the extended writing configuration requires sideward pressure from spring clip 48. As spring clip 48 fatigues over time, the pressure will loosen and the pen may fail to lock in the writing configuration.

Hsieh '224 (U.S. Pat. No. 6,921,224) discloses a pen that can be opened and closed by shaking and that is capable of employing a standard plastic ball-point pen refill. Nevertheless, the pen of Hsieh '224 has significant disadvantages, at least because of the dependence on an elastic claw-shaped rear stopper. In the writing configuration (tip extended) all of the writing force rests on the elastic claw-shaped stopper. Therefore the stopper must be stiff and strong. On the other hand, elastic claw-shaped rear stopper must be supple enough to move easily into and out of the slots in the sliding ring 40 and the tail 13 of the pen. Thus, the flexibility of the elastic claw-shaped rear stopper must be precisely configured; poor machining of the parts or fatigue may cause the pen to work improperly.

It is therefore an object of the present invention, to provide a retraction mechanism with a minimal of moving parts, which can be opened and closed with one hand, with any grip.

It is another object of the present invention, to provide a writing instrument having a retraction mechanism with a minimal number of moving parts, which can be opened and closed with one hand while gripping the instrument for writing.

It is another object of the present invention, to provide a retractable ball-point pen mechanism using standard parts, with a minimal of moving parts, which can be opened and closed with one hand while gripping the instrument for writing.

It is another object of the present invention, to provide a retractable ball-point pen mechanism using a standard refill, with a minimal of moving parts, which can be opened and closed with one hand while gripping the instrument for writing.

It is another object of the present invention, to provide a retractable ball-point pen using standard parts, with a minimal of moving parts, which can be stored in any attitude and which can be opened and closed with one hand while gripping the instrument for writing.

It is another object of the present invention, to provide a retraction mechanism with a minimal number of moving parts, which can be opened and closed by shaking.

It is another object of the present invention, to provide a retractable point instrument with a minimal of moving parts, which can be opened and closed by inverting.

It is another object of the present invention, to provide a unique retractable point instrument with a custom refill.

Other objects and advantages of the invention will become apparent as the description proceeds.

### SUMMARY OF THE INVENTION

The present invention describes a retraction mechanism and a method for retraction of a tip.

A preferred embodiment of a retraction mechanism may include an internal shoulder located behind a bore of a barrel and a canal located behind the internal shoulder. The retraction mechanism may also include an elongated assembly configured to slide along the bore. The retraction mechanism may also include a forcing member to impose a force on the elongated member. The retraction mechanism may further include a sliding weight configured for aligning the elongated assembly with the canal when the sliding weight is pushed toward canal, and the sliding weight may be further configured for pushing the elongated assembly forward so that the rear of the elongated assembly moves out of the canal when the sliding weight slides forward and collides with the elongated assembly. The internal shoulder may be configured such that when the elongated assembly is not aligned with the canal, the shoulder holds the elongated assembly so that the front tip of the elongated assembly projects forward. When the elongated assembly is aligned with the canal, the forcing member may drive the rear end of the elongated assembly into the canal causing the front tip of the elongated member to retract rearward

In an embodiment of a retraction mechanism, the forcing member may be the only deformable part of the mechanism.

In an embodiment of a retraction mechanism, the elongated assembly, sliding weight and forcing member may be the only parts of the retraction mechanism that are not fixed in relation to the barrel.

In an embodiment of a retraction mechanism, at least one end of said forcing member may be fixed with respect to the barrel.

In an embodiment of a retraction mechanism, the elongated assembly may include a standard pen refill.

In an embodiment of a retraction mechanism, the location of the bore may be fixed with relation to the barrel.

In an embodiment of a retraction mechanism, the location of the internal shoulder may be fixed with relation to the barrel.

In an embodiment of a retraction mechanism, the location of the canal may be fixed with relation to the barrel.

In an embodiment of a retraction mechanism, the elongated assembly may slide inside of a hollow of the sliding weight.

In an embodiment of a retraction mechanism, the elongated assembly may include a sleeve configured to hold a pen-refill.

In an embodiment of a retraction mechanism, the elongated assembly may further include a protrusion and the sliding weight may push the elongated assembly forward by colliding with the protrusion.

In an embodiment of a retraction mechanism, the protrusion may further serve to engage the forcing member to the elongated assembly.

In an embodiment of a retraction mechanism, the protrusion may include a pinched protrusion of a standard pen refill, or a protrusion added to a pen refill, or a cylindrical casing covering at least part of the elongated assembly or a nut.

In an embodiment of a retraction mechanism, the bore or the sliding weight may be beveled.

In an embodiment of a retraction mechanism, the internal shoulder, the barrel and the canal may be formed by a single mold.

In an embodiment of a retraction mechanism, the canal may be configured to reduce a probability that the elongated member will spontaneously align with the canal. In this preferred embodiment, the slight curvature of standard manufactured refills may be utilized to further reduce the probability that the elongated member will spontaneously align with the canal.

In an embodiment of a retraction mechanism, the elongated member may have a non-circular cross-section.

In an embodiment of a retraction mechanism, when the front tip projects forward, the front tip may protrude out from the front of the bore.

In an embodiment of a retraction mechanism, when the front tip retracts, the front tip may retract into the front of the bore.

In an embodiment of a retraction mechanism, the retracting may be instigated by shaking or inverting the mechanism.

In an embodiment of a retraction mechanism, the front tip may include a ball point pen, a fountain pen, a marker, a roll on applicator or a screwdriver or a box cutter (sometimes referred to as a utility knife) or a blade.

### BRIEF DESCRIPTION OF THE DRAWINGS

In the drawings:

FIG. 1a schematically shows a semi-cut-away view of a first embodiment of a retraction mechanism in a ball-point pen in the open configuration.

FIG. 1b schematically shows a semi-cut-away view of a first embodiment of a retraction mechanism in a ball-point pen in the closed configuration.

FIG. 2a schematically shows a full cut-away view of a first embodiment of a retraction mechanism in a ball-point pen in the open configuration.

FIG. 2b schematically shows a full cut-away view of a first embodiment of a retraction mechanism in a ball-point pen in the closed configuration.

FIG. 3a schematically shows a full cut-away view of a second embodiment of a retraction mechanism in a ball-point pen in the open configuration.

FIG. 3b schematically shows a full cut-away view of a second embodiment of a retraction mechanism in a ball-point pen in the closed configuration.

FIG. 4a schematically shows a full cut-away view of a third embodiment of a retraction mechanism in a ball-point pen in the open configuration.

FIG. 4b schematically shows a full cut-away view of a third embodiment of a retraction mechanism in a ball-point pen in the closed configuration.

FIG. 5a schematically shows a full cut-away view of the rear portion of a fourth embodiment of a retraction mechanism in a ball-point pen in the open configuration.

FIG. 5b schematically shows a full cut-away view of the rear portion of a fourth embodiment of a retraction mechanism in a ball-point pen in transition between open and closed configurations.

FIG. 5c schematically shows a full cut-away view of the rear portion of a fourth embodiment of a retraction mechanism in a ball-point pen in the closed configuration.

FIG. 6a schematically shows a full cut-away view of the rear portion of a fifth embodiment of a retraction mechanism in a ball-point pen in the open configuration.

FIG. 6b schematically shows a full cut-away view of the rear portion of a fifth embodiment of a retraction mechanism in a ball-point pen in transition between open and closed configurations.

FIG. 6a schematically shows a full cut-away view of the rear portion of a fifth embodiment of a retraction mechanism in a ball-point pen in the closed configuration.

### DETAILED DESCRIPTION OF THE INVENTION

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice. Moreover, it is to be understood that the phraseology and terminology employed herein is for the purpose of description and should not be regarded as limiting the scope of the invention hereof.

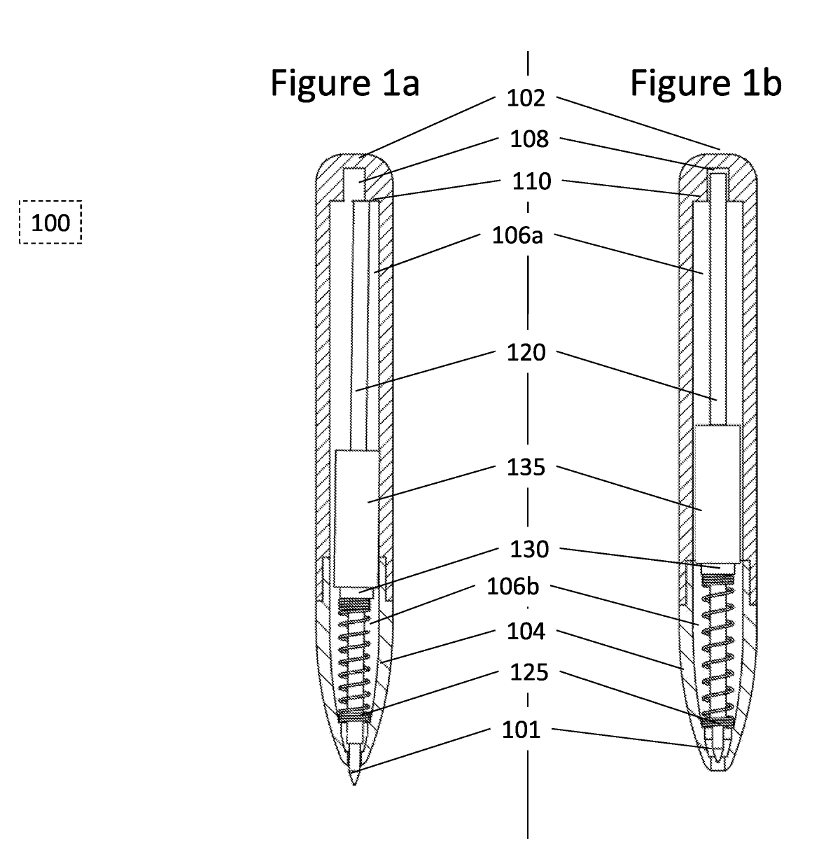

FIG. 1a schematically shows an embodiment 100 of a pen in an open configuration with writing tip 101 projected out of the front end of the pen, and FIG. 1b schematically shows embodiment 100 in a closed configuration with writing tip 101 retracted. The body of embodiment 100 is preferably approximately cylindrical and made up of two sections, the rear section includes a barrel 102 and the front section includes a pen nib 104. Barrel 102 and pen nib 104 are preferentially detachably joined by a threaded connection to form the body of the pen In FIGS. 1a and 1b, the pen body is shown cut away to reveal the inside of barrel 102 which is hollowed to form a bore 106a and the inside of pen nib 104 which is hollowed to form a bore 106b. Bore 106a is in alignment with bore 106b when barrel 102 and pen nib 104 are joined.

At the rear end, opposite writing tip 101, bore 106a abruptly thins to a rear canal 108. In embodiment 100, barrel 102 is a single piece, but in an alternative embodiment, the rear portion of barrel 102 containing rear canal 108 could be a separate part detachably joined to barrel 102 by a threaded connector. In such an alternative embodiment (where the rear end of the pen is removable), the pen nib and barrel may be permanently joined (for example they may constitute a single molded part) and the pen refill may be inserted from the rear of the pen.

Where the thin rear canal 108 meets the wider bore 106a there is formed an internal shoulder 110. In embodiment 100, thin rear canal 108 and wider bore 106a both have a cylindrical form and circular cross-section and are aligned concentrically so that internal shoulder 110 has a ring form. Alternatively, bore 106a and rear canal 108 need not have a circular cross section and may be offset from one another. Particularly, for retractable instruments such as screw drivers or knives, it may be preferable for the elongated assembly to have a non-circular cross-section that locks into a non-circular opening in pen nib 104 in order to avoid rotation of the instrument with respect to the pen body.

In embodiment 100, writing tip 101 is part of an elongated assembly which is a standard pen refill consisting of an ink tube 120, a protrusion 130 and writing tip 101. In embodiment 100, protrusion 130 is a ring attached to ink tube 120. Protrusion 130 may be an integral part of ink tube 120 or may be a separate piece that is permanently or detachably attached to ink tube 120. As is well known in the art, in standard pen refills, protrusion 130 may be a pinched portion of ink tube 120 that is configured to engage and hold back a forcing member. In embodiment 100 the forcing member is a compression spring 125. The front end of compression spring 125 is fixed to the front of pen nib 104. When compression spring 125 is engaged to protrusion 130, compression spring 125 forces the refill (writing tip 101, ink tube 120 and protrusion 130) towards the rear end of the pen body.

Alternatively a forcing member may be a deformable elastic plastic leaf or stretchable band or a magnet or other suitable material. The force may be a compression or stretching force of a deformable member or an electromagnetic force. For a softer resistance of the forcing member, sliding weight 135 may be configured to be lighter, and as a result, the overall weight of the retracting mechanism may be reduced. Moreover, the decrease in weight and size can be utilized to design finer instruments.

In the open configuration of FIG. 1a, the rear end of ink tube 120 is in contact with internal shoulder 110 which prevents ink tube 120 from moving rearward into rear canal 108. The length of the pen refill (the combined length of ink tube 120 and writing tip 101) is greater than the combined lengths of bores 106a and 106b. Therefore when the rear of ink tube 120 is in contact with internal shoulder 110, writing tip 101 extends out of the front of pen nib 104 as illustrated in FIG. 1a. In the open configuration of FIG. 1a, compression spring 125 holds ink tube 120 firmly against internal shoulder 110. Thus writing tip 101 is held firmly in the protruding position without play, making the pen of embodiment 100 a comfortable writing instrument.

In the closed configuration of FIG. 1b, the rear end of ink tube 120 is pushed by compression spring 125 into rear canal 108. The combined length of rear canal 108, bore 106a and bore 106b is slightly longer than the length of the elongated member (the pen refill including ink tube 120 and writing tip 101). Therefore when the rear portion of ink tube 120 is pushed into rear canal 108, writing tip 101 is retracted into bore 106b as illustrated in FIG. 1b.

A sliding weight 135, preferentially in the form of a steel cylinder with a concentric cylindrical hollow, is provided for switching the pen of embodiment 100 between the closed configuration (FIG. 1b) and the open configuration. (FIG. 1a). Sliding weight 135 slides freely along bore 106a and also slides freely over ink tube 120, which is confined within the hollow of sliding weight 135. The hollow of sliding weight 135 is aligned with rear canal 108. In general, a short sliding weight may improve functionality during the retraction of the mechanism, especially when applied in thin instruments.

When the pen is in the open configuration of FIG. 1a, forcing sliding weight 135 rearwards towards rear canal 108 causes the pen to switch to the closed configuration. Sliding weight 135 may be forced forward or rearward by shaking the pen upwards and downwards or by tipping the pen. The method and force necessary to force sliding weight 135 forward or rearward may depend on the application, the geometry of internal shoulder 110, the materials used, the size of sliding weight 135 and the stiffness of compression spring 125. Specifically, because ink tube 120 is confined within the hollow of sliding weight 135 and the hollow of sliding weight 135 is aligned with rear canal 108, forcing sliding weight 135 backwards forces the rear portion of ink tube 120 to slide off of internal shoulder 110 and into alignment with rear canal 108. Once ink tube 120 is aligned with rear canal 108, compression spring 125 forces the rear portion of ink tube 120 into the closed configuration inside rear canal 108 retracting writing tip 101 into pen nib 104 as illustrated in FIG. 1b.

When the pen is in the closed configuration of FIG. 1b, forcing sliding weight 135 forward causes sliding weight 135 to collide with protrusion 130 and push protrusion 130 and hence all of the elongated member (writing tip 101, protrusion 130 and ink tube 120) forward. This compresses compression spring 125 and causes ink tube 120 to slide out of canal 108. Once ink tube 120 leaves canal 108, compression spring 125 pushes ink tube 120 back towards rear canal 108.

The entrance to rear canal 108 is configured so that ink tube 120 is unlikely to spontaneously align with rear canal 108. This is accomplished in embodiment 100 by making the diameter of the entrance to rear canal 120 small (just fitting ink tube 120) so that ink tube 120 will only enter rear canal 108 when ink tube 120 and rear canal 108 are precisely aligned. A small misalignment prevents ink tube 120 from entering rear canal 108 and causes ink tube 120 to lock against internal shoulder 110 locking the pen in the open configuration. Preferably, the probability of ink tube 120 spontaneously being precisely aligned with rear canal 108 is as small as possible while allowing easy closing of the pen when sliding weight 135 is forced rearward aligning ink tube 135 and rear canal 108. Preferably rear canal 108 is 0.5 mm larger than the rear of the elongated assembly (in embodiment 100 this means that the diameter of rear canal 108 is 0.5 mm greater than the diameter of ink tube 120). Furthermore, due to machining imprecision, ink tube 120 may not be perfectly straight further decreasing the probability of spontaneous alignment between ink tube 120 and rear canal 108. Therefore, once pulled out of rear canal 108 ink tube 120 will probably be pushed into internal shoulder 110 and held in the open configuration of FIG. 1a until sliding weight 135 is again forced backwards forcing ink tube 120 back into precise alignment with rear canal 108. By the above mechanism, based only on probability of alignment, forcing sliding weight 135 forward will usually open the pen regardless of the attitude of the pen (whether it is held tip down, tip up or on a slant).

In various alternative embodiments, the rear canal may be from 0.1 mm to 1.0 mm larger than the rear of the elongated assembly (the rear canal should be as small as possible but large enough for elongated assembly to easily enter the rear canal when the rear canal and the elongated assembly are aligned by the sliding weight in its rearward position). This would correspond to a probability of spontaneous closure of the pen from fully extruded configuration (when the elongated assembly is extruded beyond the open writing configuration, beyond the point of locking against inner shoulder 110) of less then 5%. In the preferred embodiment the probability of spontaneous closure from the fully extruded configuration is less than 1%. It should be noted that this low probability of spontaneous closure is not dependent on the attitude at which the pen is held.

Alternatively, rear canal 108 and ink tube 120 and the hollow of sliding weight 135 may be of a non-circular cross section (for example square- or star-shaped). In such an embodiment unintended closing of the pen by chance alignment of ink tube 120 and rear canal 108 is even more improbable than for a round cross section because for a circular cross section the pen will close when ink tube 120 is translationally aligned with rear canal 108, in contrast, for non-circular cross-section, the pen will only close when ink tube 120 and rear canal 108 are both translationally and rotationally aligned. This dual alignment is very unlikely unless the user purposely forces both translational and rotational alignment of ink tube 120 and rear canal 108 by forcing sliding weight 135 backwards. In such a case sliding weight 135 may have a mechanism (for example a non-circular cross-section) to align sliding weight 135 with rear canal 108 and ink tube 120 when sliding weight 135 is in the rearward position.

The method by which a user will open and close the pen depends on the ratio of the mass of sliding weight 135 and the retaining force of compression spring 125. Particularly, if compression spring 125 is soft and sliding weight 135 is heavy, then when the pen is tipped with writing tip 101 downward, the weight of sliding weight 135 will pull ink tube 120 out of rear canal 108 opening the pen. This situation may be undesirable because the pen may open unexpectedly (staining clothes etc.). Furthermore, when held with writing tip 101 downward, ink tube 120 will not be pushed up against internal shoulder 110 and the writing tip 101 will move slightly inward before commencing to write. Preferably, for a stiffer compression spring 125 and a lighter sliding weight 135 opening the pen will require a brisk shake of the pen to cause the weight to travel forward with momentum that will pull ink tube 120 out of rear canal 108. Similarly, a brisk shake of the pen in the opposite direction will push sliding weight backwards with high momentum, dislodging ink tube 120 from interior shoulder 110 and aligning ink tube 120 with rear canal 108 such that compression spring 125 pushes ink tube 120 into rear canal 108, closing the pen. For a standard ball-point pen spring, the preferred weight for sliding weight 135 is approximately 4.5 g. For smaller, thinner pens it is possible to use a softer spring as the forcing member and a lighter sliding weight 135. Alternatively, compression spring 125 could be replaced by another mechanism, for example a deformable piece of elastic plastic.

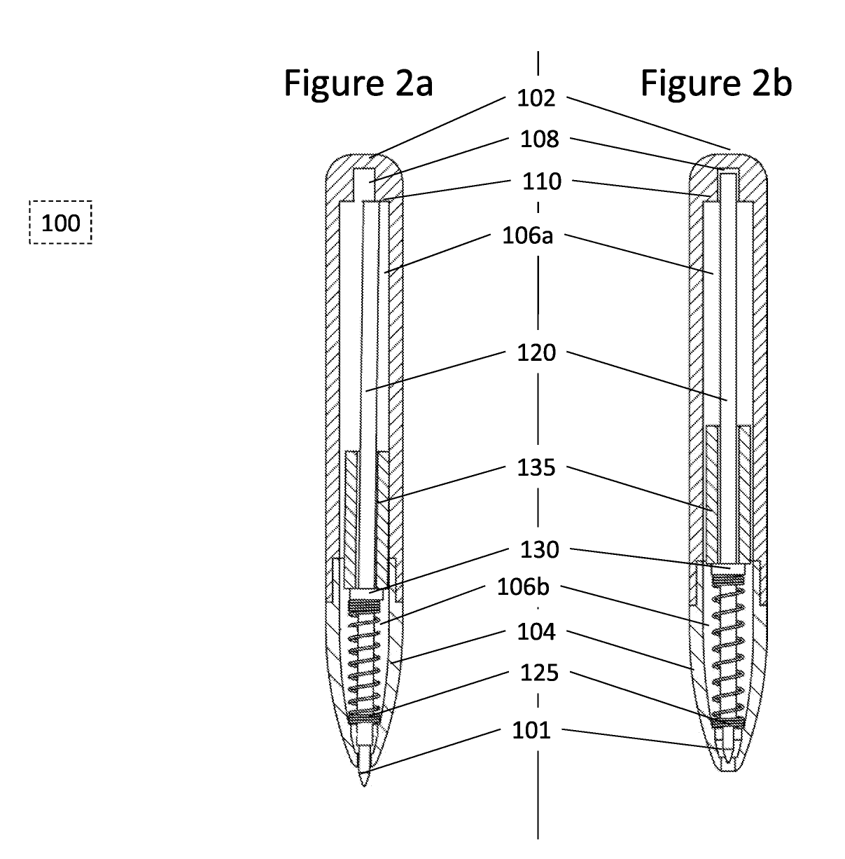

FIGS. 2a and 2b are further illustrations of embodiment 100 and are similar to FIGS. 1a and 1b, except that sliding weight 135 is shown in FIGS. 2a and 2b in a cut-away view, exposing the hollow core of sliding weight 135. All numbers and part identities in FIGS. 1a and 1b correspond to those of FIGS. 2a and 2b.

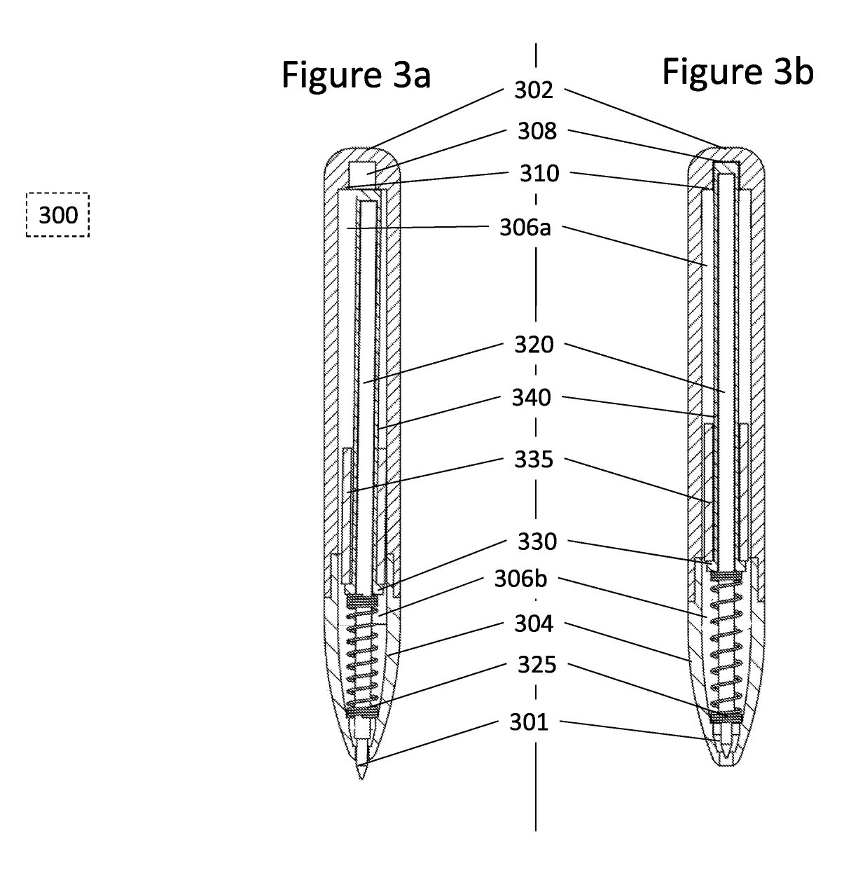

FIGS. 3a and 3b illustrate a second embodiment 300 of a retraction mechanism for a pen in an open and closed configuration, respectively. Embodiment 300 functions in a similar manner to embodiment 100 and includes similar parts. Particularly, embodiment 300 includes a pen body made up of two sections, a barrel 302 forms the rear section and a pen nib 304 forms the front section. Each section is hollowed out to form a bore 306a inside of barrel 302 and a bore 306b inside of pen nib 304. Bore 306a is in alignment with bore 306b when barrel 302 and pen nib 304 are joined. At the rear end, opposite to writing tip 301, bore 306a abruptly thins to a rear canal 308. Where rear canal 308 meets bore 306a there is formed an internal shoulder 310. Embodiment 300 also includes a forcing member which is a compression spring 325 and a sliding weight 335, similar to embodiment 100.

The elongated assembly of embodiment 300 includes a writing tip 301 and ink tube 320 similar to embodiment 100 but in contrast to embodiment 100, the elongated assembly of embodiment 300 includes a sleeve 340 which surrounds ink tube 320. Sleeve 340 includes a protrusion 330. When sliding weight 335 is forced forward, sliding weight 335 will collide with protrusion 330 causing the pen to open (similarly to the mechanism described above when sliding weight 135 collides with protrusions 130). In embodiment 300 protrusion 330 also serves for engaging compression spring 325.

Alternatively, ink tube 320 may have a separate protrusion to engage compression spring 325. In such an alternative embodiment compression spring 325 would press against the protrusion on ink tube 320 forcing ink tube 320 into sleeve 340. In such an alternative embodiment the force of ink tube 320 against sleeve 340 would lock sleeve 340 against shoulder 310 when the pen is in the open configuration and hold sleeve 340 inside rear canal 308 when the pen is in the closed configuration.

The opening and closing action of embodiment 300 is exactly analogous to embodiment 100, except that to close embodiment 300, sleeve 340 is aligned with rear canal 308, as opposed to the alignment of ink tube 120 with rear canal 108. An advantage of embodiment 300 over embodiment 100 is that the only part that directly interacts with the pen refill (ink tube 320 and writing tip 301) is sleeve 340. This makes it possible to adjust the geometry of bore 306a and 306b and rear canal 308 and sliding weight 335 (for instance to have a non-circular cross section) and still use a standard pen refill (inserted into sleeve 340).

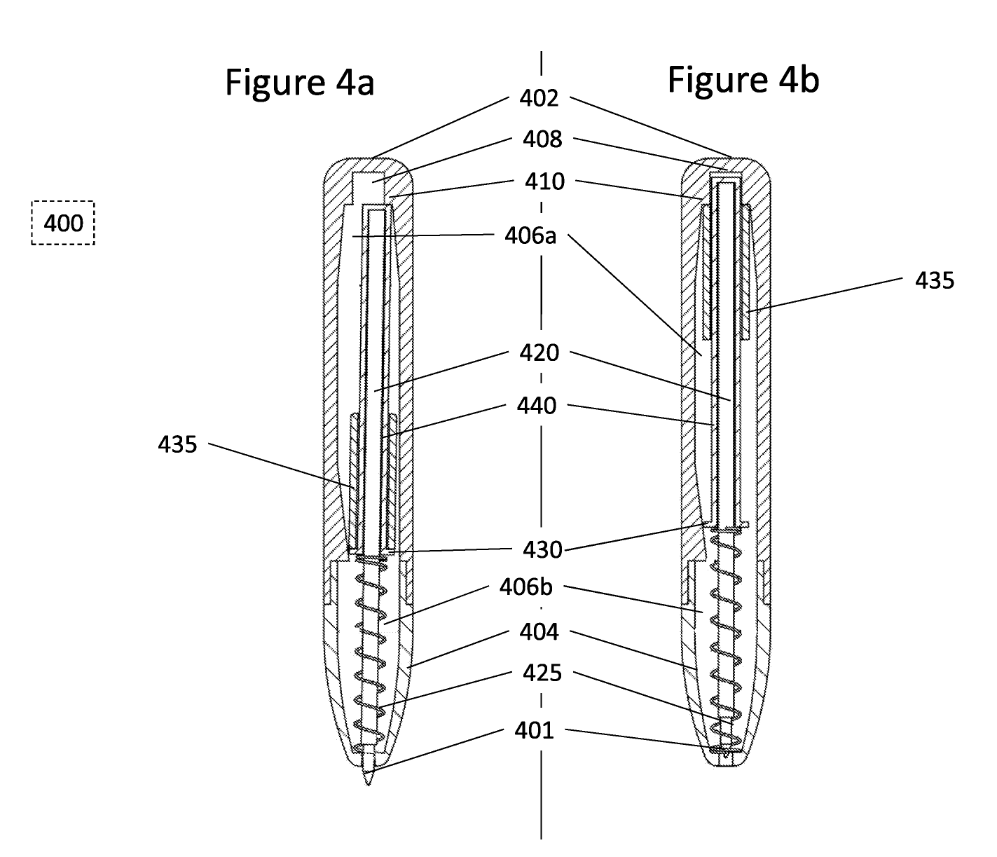

FIGS. 4a and 4b illustrate a third embodiment 400 of a retraction mechanism for a pen in an open and closed configuration respectively. Embodiment 400 functions in a similar manner to embodiment 300 and includes similar parts. Particularly, embodiment 400 includes a pen body made up of two sections, the rear section is a barrel 402 and the front section is a pen nib 404. Each section is hollowed out to form a bore 406a inside of barrel 402 and a bore 406b inside of pen nib 404. Bore 406a is in alignment with bore 406b when barrel 402 and pen nib 404 are joined. At the rear end, opposite to writing tip 401, bore 406a abruptly thins to a rear canal 408. Where rear canal 408 meets bore 406a there is formed an internal shoulder 410. Embodiment 400 also includes a forcing member which is a compression spring 425 and a sliding weight 435, similar to embodiment 300.

Similar to embodiment 300, the elongated assembly of embodiment 400 includes a writing tip 401, an ink tube 420 and a sleeve 440 which surrounds ink tube 420 and has a protrusion 430 for engaging compression spring 425.

Embodiment 400 differs from embodiment 300 in that bore 406a is beveled. Particularly, the beveling of the rear portion of bore 406a as it approaches rear canal 408 aids in centralizing sliding weight 435 to gradually align sleeve 440 with rear canal 408 as sliding weight 435 is forced rearward. This makes closing the pen of embodiment 400 easier than closing the pen of embodiment 300. Alternatively or additionally, sliding weight 435 may also be beveled mutatis mutandis.

In embodiment 400 bore 406b is also beveled so that when sliding weight 435 is in a forward position (as shown in FIG. 4a) sliding weight 435 will tend to tilt. Tilting further ensures that sleeve 440 will remain locked against interior should 410 and not spontaneously returned to the closed configuration. Alternatively, in a case where rear canal 408 has a non-circular cross section, bore 406b may be configured to cause sliding weight 435 to rotate sleeve 440 when the pen reaches the open configuration further preventing spontaneous closing of the pen.

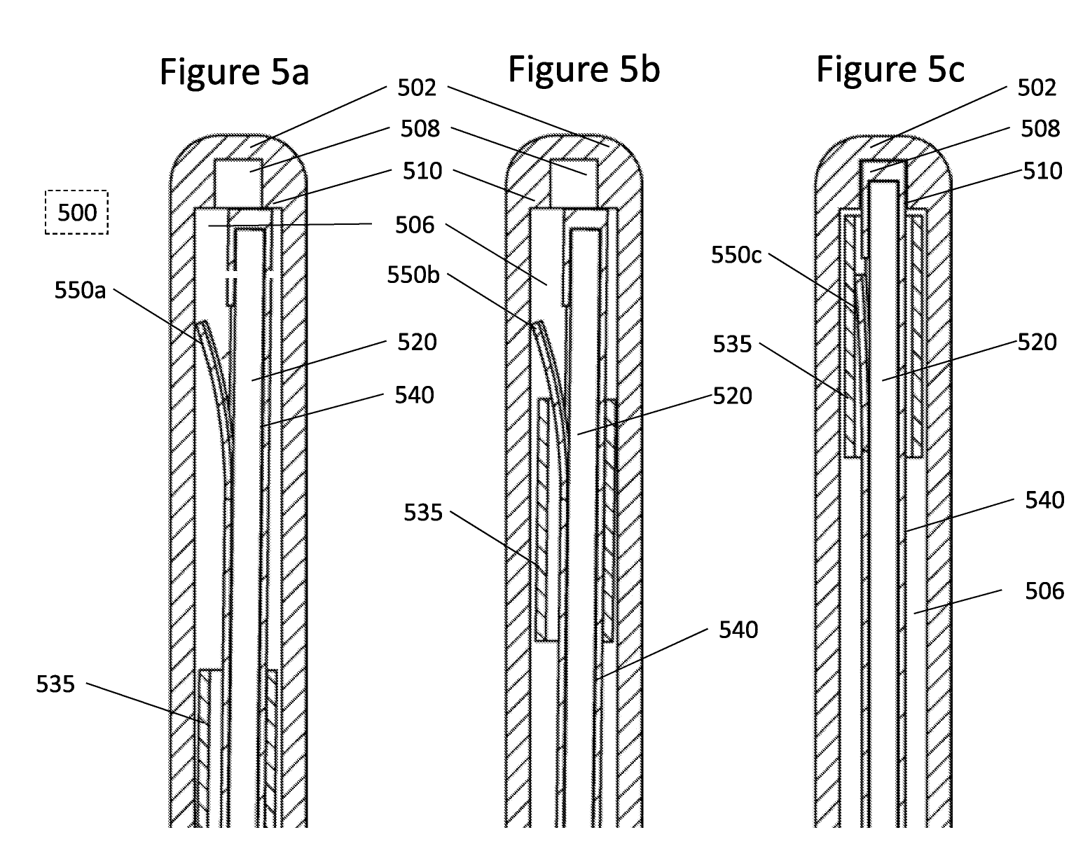

FIGS. 5a, 5b, and 5c illustrate a close up view of the rear section of a fourth embodiment 500 of a retraction mechanism for a pen in the open, closing and closed configurations, respectively. The front end of the pen is similar to embodiment 300 and is not shown.

Particularly, embodiment 500 includes a pen body including a barrel 502, which is hollowed out to form a bore 506. Bore 506 abruptly thins to a rear canal 508. Where rear canal 508 meets bore 506 there is formed an internal shoulder 510. Embodiment 500 also includes a sliding weight 535.

The elongated assembly of embodiment 500 includes ink tube 520 and includes a sleeve 540 which surrounds ink tube 520. In contrast to embodiment 300, embodiment 500 includes an elastic leaf 550a, b, c which is connected to sleeve 540.

In FIG. 5a, leaf 550a is illustrated in the open position wherein the pen's tip is extruded out of the pen's body. In the open position leaf 550a pushes sleeve 540 out of alignment with rear canal 508 and locks the pen in the open configuration.

In FIG. 5b, leaf 550b is illustrated in a transitional configuration as sliding weight 535 slides over leaf 550b, switching between the open and closed configurations. In FIG. 5c, leaf 550c is illustrated in the closed position. In the closed position, leaf 550c has been pushed against ink tube 520 by sliding weight 535 and sliding weight 535 has pushed sleeve 540 into alignment with rear canal 508 so that sleeve 540 has been pushed by the compression spring 525 into rear canal 508, putting the pen into the closed configuration.

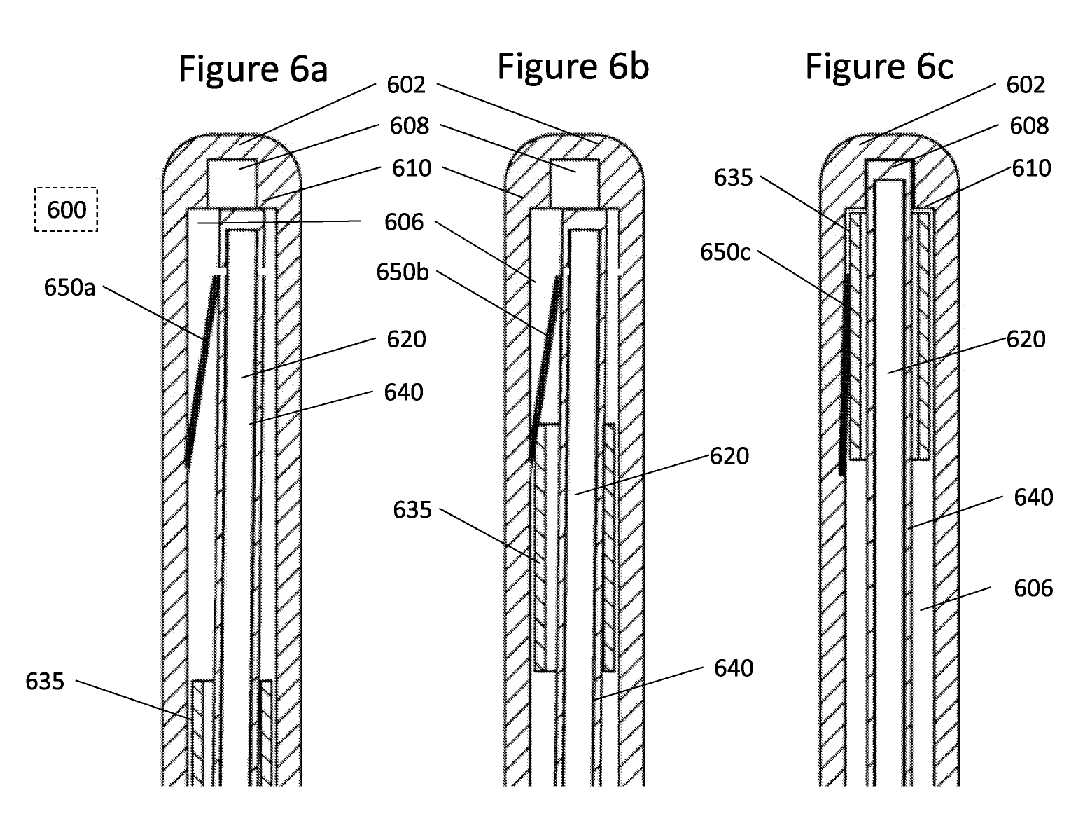

FIGS. 6a, 6b, and 6c illustrate a close up view of the rear section of a fifth embodiment 600 of a retraction mechanism for a pen in the open, transitional and closed configurations, respectively. The front end of the pen is not shown as it is similar to embodiment 300.

Particularly, embodiment 600 includes a pen body including a barrel 602 which is hollowed out to form a bore 606. Bore 606 abruptly thins to a rear canal 608. Where rear canal 608 meets bore 606 there is formed an internal shoulder 610. Embodiment 600 also includes a sliding weight 635.

The elongated assembly of embodiment 600 includes ink tube 620 and includes a sleeve 640 which surrounds ink tube 620.

In contrast to embodiment 500, in embodiment 600 an elastic leaf 650a, b, c is connected to the inside wall of barrel 602. In a similar alternative embodiment, an elastic leaf similar to elastic leaf 650a could be added to embodiment 100 without needing a sleeve such as sleeve 640.

In FIG. 6a, leaf 650a is illustrated in the open position. In the open position leaf 650a pushes sleeve 640 out of alignment with rear canal 608 and locks the pen in the open configuration with the pen tip extruded out.

In FIG. 6b, leaf 650b is illustrated as sliding weight 635 moves over leaf 650b.

In FIG. 6c, leaf 650c is illustrated in the closed position. In the closed position leaf 650c has been pushed against the inner wall of barrel 602 by sliding weight 635 and sliding weight 635 has pushed sleeve 640 into alignment with rear canal 608 so that sleeve 640 has been pushed into rear canal 608 putting the pen into the closed configuration.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A retraction mechanism comprising:
A) an internal shoulder located behind a bore of a barrel;
B) a canal located behind said internal shoulder;
C) an elongated assembly configured to slide along said bore;
D) a forcing member, and
E) a sliding weight configured
i) for aligning a rear end of said elongated assembly with said canal when said sliding weight slides in rearward, and
ii) for pushing said elongated assembly forward, out of said canal when said sliding weight slides forward, and
wherein said internal shoulder is configured such that when said rear end of said elongated assembly is not aligned with said canal, said internal shoulder prevents said rear end of said elongated assembly from entering said canal thus preventing retraction of said elongated assembly; and said forcing member configured for driving said rear end of said elongated assembly into said canal thereby retracting said elongated member when said rear end of said elongated assembly is aligned with said canal.

2. The retraction mechanism of claim 1, wherein said forcing member is deformable and all other parts of the retraction mechanism are substantially not deformable.

3. The retraction mechanism of claim 1, wherein said elongated assembly, said sliding weight and said forcing member are configured to move with respect to said barrel and all other parts of the retraction mechanism that substantially fixed with respect to said barrel.

4. The retraction mechanism of claim 1, wherein at least one end of said forcing member is fixed with respect to said barrel.

5. The retraction mechanism of claim 1, wherein said elongated assembly includes a standard pen refill.

6. The retraction mechanism of claim 1, wherein said bore is substantially fixed with respect to said barrel.

7. The retraction mechanism of claim 1, wherein said internal shoulder is substantially fixed with respect to said barrel.

8. The retraction mechanism of claim 1, wherein said canal is substantially fixed with respect to said barrel.

9. The retraction mechanism of claim 1, wherein said elongated assembly slides inside of a hollow of said sliding weight.

10. The retraction member of claim 1, wherein said elongated assembly further includes a protrusion and wherein said pushing is by said sliding weight pushing against said protrusion.

11. The retraction mechanism of claim 10, wherein said protrusion further serves to engage said forcing member.

12. The retraction mechanism of claim 10, wherein said protrusion includes at least one element selected from the group containing a pinched protrusion of a standard pen refill, a cylinder encasing at least part of said elongated assembly, a protrusion added to a pen refill and a nut.

13. The retraction mechanism of claim 1, wherein said bore is beveled.

14. The retraction mechanism of claim 1, wherein said internal shoulder, said barrel and said canal are formed by a single mold.

15. The retraction mechanism of claim 1, wherein said canal is configured to reduce a probability that said elongated member will spontaneously align with said canal.

16. The retraction mechanism of claim 1, wherein said elongated member has a non-circular cross-section.

17. The retraction mechanism of claim 1, wherein a front tip of said elongated assembly protrudes from said bore when said rear end of said elongated assembly is not retracted into said canal.

18. The retraction mechanism of claim 1, wherein a front tip of said elongated assembly retracts into said bore when said rear end of said elongated assembly retracts into said canal.

19. The retraction mechanism of claim 1, wherein said retracting is instigated by at least one action selected from the group containing shaking and inverting.

20. The retraction mechanism of claim 1, wherein said front tip includes at least one tool selected from the group containing a ball point pen, a fountain pen, a marker, a roll on applicator, a blade, a box cutter and a screwdriver.

21. The retraction mechanism of claim 1, wherein said elongated assembly is configured to reduce a probability that said elongated member will spontaneously align with said canal.
